(19) United States
(12) Patent Application Publication
(10) Pub. No.: US 2007/0285781 A1
(43) Pub. Date: Dec. 13, 2007

(54) Beam Shaping Optical System And Optical System Of Laser Beam Printer

(76) Inventors: Daisuke Seki, Osaka (JP); Kouei Hatade, Osaka (JP)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 11/579,043

(22) PCT Filed: Apr. 28, 2005
(86) PCT No.: PCT/JP05/08224

§ 371 Date: Feb. 14, 2007

(30) Foreign Application Priority Data
Apr. 30, 2004 (JP) 2004-136515

(51) Int. Cl. G02B 27/09

(52) U.S. Cl. 359/566

(57) ABSTRACT

There is provided an axially asymmetric beam shaping optical system causing no astigmatism for variation in refractive index incident to an external cause, e.g. variation in wavelength of a light source or variation in ambient temperature. The system has a diffraction grating plane as follows. Assuming the optical axis is the z-axis and a plane perpendicular to the optical axis is the xy plane, the phase function in the x-axis direction and the y-axis direction of the diffraction grating plane is determined to minimize astigmatism by equalizing variation in distance from the light source to an image forming point or a virtual image point on the xz plane and variation in that distance on the yz plane. Furthermore, the system has a diffraction grating plane as follows. The phase function in the x-axis direction and the y-axis direction of the diffraction grating plane is determined to minimize astigmatism by equalizing variation in distance from the light source to the image forming point or the virtual image point on the xz plane and variation in that distance on the yz plane for temperature variation.

### TECHNICAL FIELD

The present invention relates to a beam shaping optical system having an axially asymmetric profile and shaping the shape of a beam from a light source and a laser beam printer optical system having an axially asymmetric profile and including a beam shaping element for shaping the shape of a beam from a light source.

In particular, the present invention relates to a beam shaping optical system and a laser beam printer optical system comprising a diffraction grating surface that has determined a phase function so as to minimize astigmatism.

### BACKGROUND ART

Devices using a semiconductor laser as a light source include an optical pickup device for an optical recording medium, a scanning optical system such as a laser printer, a laser machining device, and an optical communication device. In these devices, there are many cases where it is preferable for the portion, where the ratio of the energy value at the beam section perpendicular to the optical axis to the peak value is equal to or greater than a fixed value, to have the shape of an axially symmetric circle or the shape of an ellipse having a small aspect ratio, from the standpoint of the energy efficiency and reduction in aberration.

On the other hand, the width and the thickness of an active layer corresponding to the beam waist location of a semiconductor laser, which is a light source, are considerably different from each other. Because of this, the divergence angle of an emitted ray bundle in the direction of the plane parallel to the active layer is about one-third to one-sixth of the divergence angle in the vertical direction and the portion where the ratio of the energy value at the beam section perpendicular to the optical axis to the peak value is equal to or greater than a fixed value has the shape of an ellipse. When the ray bundle is turned into a parallel ray bundle using an axially symmetric collimator, the portion where the ratio of the energy value at the beam section perpendicular to the optical axis of the parallel beam obtained as a result to the peak value is equal to or greater than a fixed value still has the shape of an ellipse.

An axially asymmetric beam shaping element is known, which performs beam shaping of such an elliptic beam emitted from a semiconductor laser into the shape of a circle or the shape of an ellipse having an arbitrary ratio between its major axis and minor axis while suppressing the wave aberration so that the beam conforms to the optical characteristics of a device to which the beam is applied. For example, refer to the following documents.

(1) Japanese Unexamined Patent Publication No. 61-254915

(2) Japanese Unexamined Patent Publication No. 6-294940

### DISCLOSURE OF THE INVENTION

However, in an axially asymmetric beam shaping element, the refractive power is different between the x axis direction and the y axis direction when the optical axis is taken as the z-axis. Due to this, there arises a problem that in an axially asymmetric beam shaping element, the variation in the optical characteristics is different between the x axis direction and the y axis direction for the variation in the refractive index accompanying external factors such as the variation in the wavelength of a light source and a change in the environmental temperature, and therefore a large astigmatism is caused to occur.

FIG. 1 is a ray diagram of a beam shaping element at a section parallel to an active layer of a semiconductor laser as a light source and FIG. 2 is a ray diagram of a beam shaping element at a section perpendicular to the active layer.

As shown in FIG. 1 and FIG. 2, the ray bundle from the active layer of the semiconductor laser changes in its divergence angles both in the parallel direction and in the both vertical directions by passing through the beam shaping element. At this time, the wave aberration of the ray bundle after emission is sufficiently low and beam shaping is performed so as to have spherical waves generally. Therefore, the virtual image point of the emitted ray bundle on a plane parallel to the active layer coincides with the virtual image point of the emitted ray bundle on a plane perpendicular thereto on the optical axis. Alternatively, when the emitted ray bundle is particularly collimated plane waves, their virtual image points coincide with each other at a point at infinity.

When a change in the refractive index occurs accompanying the change in the light source wavelength and the change in the external environment, the virtual image point also moves in accordance with the change in the refractive power. In such an axially asymmetric optical element in which the power differs between the parallel direction and the vertical direction, the shift amount of virtual image point differs between the parallel section and the vertical section, thus resulting in occurrence of a large astigmatism.

In particular, in such a short wavelength region used for a blue ray disc, the influence of chromatic aberration when the oscillation frequency of the light source varies becomes so large that it cannot be ignored. Further, in a scanning optical system having large image magnification such as a laser beam printer, the occurrence of astigmatism due to the variation in the environment results in a shift of the image forming position between the direction parallel to the scanning direction and the direction perpendicular thereto. Because of this, it was not possible to use an axially asymmetric beam shaping element in a laser beam printer optical system.

Therefore, there is a need for an axially asymmetric beam shaping optical system that does not cause astigmatism to occur for the variation in the refractive index accompanying external factors such as the variation in the light source wavelength and a change in the environmental temperature.

A beam shaping optical system according to the present invention includes a beam shaping element having an axially asymmetric profile, for shaping the shape of a beam from a light source. The beam shaping optical system according to the present invention comprises a diffraction grating surface that has determined a phase function in the x axis direction and in the y axis direction so as to minimize astigmatism by causing the change in the inverse of a distance from the light source to the image forming point or the virtual image point on the xz plane to be equal to the change in the inverse of a relevant distance on the yz plane for the change in the light source wavelength when the optical axis is taken as the z axis and the plane vertical to the optical axis is taken as the xy plane.

Accordingly, in the axially asymmetric beam shaping element, it is possible to cause the change in the inverse of the distance from the light source to the image forming point or the virtual image point on the xz plane to be equal to the change in the inverse of the relevant distance on the yz plane for the change in the light source wavelength and therefore to minimize astigmatism resulting from the change in the inverse of the relevant distance.

The beam shaping optical system according to the present invention includes a beam shaping element having an axially asymmetric profile, for shaping the shape of a beam from a light source. The beam shaping optical system according to the present invention comprises a diffraction grating surface that has determined a phase function in the x axis direction and in the y axis direction so as to minimize astigmatism by causing the change in the inverse of a distance from the light source to the image forming point or the virtual image point on the xz plane to be equal to the change in the inverse of a relevant distance on the yz plane for the change in temperature when the optical axis is taken as the z axis and the plane perpendicular to the optical axis is taken as the xy plane.

Accordingly, in the axially asymmetric beam shaping element, it is possible to cause the change in the inverse of the distance from the light source to the image forming point or the virtual image point on the xz plane to be equal to the change in the inverse of the relevant distance on the yz plane for the change in temperature and therefore to minimize astigmatism resulting from the change in the inverse of the relevant distance.

In a beam shaping optical system according to one embodiment of the present invention, a phase function has been further determined in the x axis direction and in the y axis direction so as to minimize the change in the inverse of a distance from the light source to the image forming point or the virtual image point on the xz plane and the change in the inverse of a relevant distance on the yz plane for the change in the light source wavelength or the change in temperature.

Therefore, in the axially asymmetric beam shaping element, it is possible to minimize the movement (defocus) of the focal point for the change in the light source wavelength or the change in temperature.

In a beam shaping optical system according to another embodiment of the present invention, a phase function in the x axis direction and in the y axis direction has been further determined so as to minimize the amount of spherical aberration for the change in the light source wavelength or the change in temperature.

Therefore, in the axially asymmetric beam shaping element, it is possible to minimize spherical aberration for the change in the light source wavelength or the change in temperature.

In a beam shaping optical system according to another embodiment of the present invention, the phase function of the diffraction grating includes a term consisting of an even function of either or both of x and y.

In a beam shaping optical system according to another embodiment of the present invention, the light source is a semiconductor laser, the active layer of the semiconductor laser is parallel to the xz section, and the beam from the laser light source, the portion of which, where a ratio of the intensity at a plane perpendicular to the optical axis to the peak intensity is equal to or greater than a predetermined value, can be represented by an ellipse, is shaped into a beam, the portion of which, where a relevant ratio is equal to or greater than the predetermined value, can be represented by substantially a circle.

A beam shaping optical system according to another embodiment of the present invention is used in an optical pickup device.

Therefore, in the optical pick up device, it is possible to minimize astigmatism and also minimize its influence even in a short wavelength region used for a blue ray disc for the change in the light source wavelength or the change in temperature while shaping the beam from the laser light source, the portion of which, where the ratio of the intensity at a plane vertical to the optical axis to the peak intensity is equal to or greater than a predetermined value, can be represented by an ellipse, into a beam, the portion of which, where the relevant ratio is equal to or greater than the predetermined value, can be represented by substantially a circle.

In a beam shaping optical system according to another embodiment of the present invention, the light source is a semiconductor laser, the active layer of the semiconductor laser is parallel to the xz section, and the beam from the laser light source, the portion of which, where the ratio of the intensity at a plane vertical to the optical axis to the peak intensity is equal to or greater than a predetermined value, can be represented by an ellipse, is shaped into a beam, the portion of which, where the relevant ratio is equal to or greater than the predetermined value, can be represented by an ellipse the ratio between the major axis and the minor axis of which is different from that of the ellipse described above.

A beam shaping optical system according to another embodiment of the present invention is used in a laser beam printer optical system.

Therefore, in the laser beam printer optical system, it is possible to minimize astigmatism and therefore to prevent the shift in the image forming location in the direction parallel to the scanning direction and in the direction perpendicular thereto for the change in the light source wavelength or the change in temperature while shaping the beam from the laser light source, the portion of which, where the ratio of the intensity at a plane vertical to the optical axis to the peak intensity is equal to or greater than a predetermined value, can be represented by an ellipse, into a beam, the portion of which, where the relevant ratio is equal to or greater than the predetermined value, can be represented by an ellipse the ratio between the major axis and the minor axis of which is different from that of the ellipse described above.

A beam shaping optical system according to another embodiment of the present invention is constituted by a single lens. Therefore, its structure is simple and its size can be reduced.

In a beam shaping optical system according to another embodiment of the present invention, a diffraction grating surface is separated from the beam shaping element.

Accordingly, it is not necessary to mount the diffraction grating on the surface of the refractive lens of the beam shaping element, therefore, its mold can be produced easily and its manufacture is easy.

In a beam shaping optical system according to another embodiment of the present invention, the diffraction grating surface having an axially symmetric phase function and the diffraction grating surface having a phase function consisting of only x terms or y terms are separated.

Accordingly, its mold can be manufactured easily and its manufacture is easy.

In a beam shaping optical system according to another embodiment of the present invention, a diffraction grating surface having an axially symmetric phase function is overlapped on an axially symmetric refracting surface.

Accordingly, its mold can be machined on a lathe and therefore its manufacture is easy.

A laser beam printer optical system according to the present invention includes a beam shaping element having an axially asymmetric profile, for shaping the shape of a beam from a light source. The laser beam printer optical system according to the present invention comprises a diffraction grating surface that has determined a phase function in the x axis direction and in the y axis direction so as to minimize astigmatism by causing the change in the inverse of a distance from the light source to the image forming point on the xz plane to be equal to the change in the inverse of a relevant distance on the yz plane for the change in temperature when the optical axis is taken as the z axis and the plane vertical to the optical axis is taken as the xy plane.

Accordingly, in the laser beam printer optical system including a beam shaping element having an axially asymmetric profile, for shaping the shape of a beam from the light source, it is possible to cause the change in the inverse of a distance from the light source to the image forming point or the virtual image point on the xz plane to be equal to the change in the inverse of a relevant distance on the yz plane for the change in temperature and therefore to minimize astigmatism resulting from the change in the inverse of the distance.

In a laser beam printer optical system according to one embodiment of the present invention, a phase function has been further determined so as to minimize the change in the inverse of a distance from the light source to the image forming point on the xz plane and the change in the inverse of a relevant distance on the yz plane for the change in temperature.

Therefore, in the laser beam printer optical system, it is possible to minimize the movement (defocus) of the focal point for the change in temperature.

In a laser beam printer optical system according to another embodiment of the present invention, a beam shaping element shapes the beam from the laser light source, the portion of which, where the ratio of the intensity at a plane perpendicular to the optical axis to the peak intensity is equal to or greater than a predetermined value, can be represented by an ellipse, into a beam, the portion of which, where the relevant ratio is equal to or greater than the predetermined value, can be represented by an ellipse the ratio between the major axis and the minor axis of which is different from that of the ellipse described above.

Therefore, in the laser beam printer optical system, it is possible to minimize astigmatism and therefore to prevent the shift in the image forming location in the direction parallel to the scanning direction and in the direction perpendicular thereto for the change in the light source wavelength or the change in temperature while shaping the beam from the laser light source, the portion of which, where the ratio of the intensity at a plane perpendicular to the optical axis to the peak intensity is equal to or greater than a predetermined value, can be represented by an ellipse, into a beam, the portion of which, where the relevant ratio is equal to or greater than the predetermined value, can be represented by an ellipse the ratio between the major axis and the minor axis of which is different from that of the ellipse described above.

In a laser beam printer optical system according to another embodiment of the present invention, a diffraction grating surface is separated from the beam shaping element.

Accordingly, it is not necessary to mount the diffraction grating on the surface of the refractive lens of the beam shaping element, therefore, its mold can be produced easily and its manufacture is easy.

In a laser beam printer optical system according to another embodiment of the present invention, the diffraction grating surface having an axially symmetric phase function and the diffraction grating surface having a phase function consisting of only x terms or y terms are separated.

Accordingly, its mold can be produced easily and its manufacture is easy.

In a laser beam printer optical system according to another embodiment of the present invention, the diffraction grating surface having an axially symmetric phase function is overlapped on the axially symmetric refracting surface.

Accordingly, its mold can be machined on a lathe and therefore its manufacture is easy.

### BRIEF DESCRIPTION OF THE DRAWINGS

FIG. 1 is a ray diagram at a section parallel to an active layer of a semiconductor laser of a beam shaping element.

FIG. 2 is a ray diagram at a section perpendicular to the active layer of the semiconductor laser of the beam shaping element.

FIG. 3 is a ray diagram at the xz section of a beam shaping element in a numerical value example 1.

FIG. 4 is a ray diagram at the yz section of the beam shaping element in the numerical value example 1.

FIG. 5 is a diagram showing a relationship between the variation in wavelength and aberration of a beam shaping element not having an astigmatism correction function.

FIG. 6 is a diagram showing a relationship between the variation in wavelength and aberration of the beam shaping element in the numerical value example 1.

FIG. 7 is a ray diagram at the xz section of a beam shaping element in a numerical value example 2.

FIG. 8 is a ray diagram at the yz section of the beam shaping element in the numerical value example 2.

FIG. 9 is a diagram showing a relationship between the variation in temperature and aberration of a beam shaping element not having an astigmatism correction function.

FIG. 10 is a diagram showing a relationship between the variation in temperature and aberration of the beam shaping element in the numerical value example 2.

FIG. 11 is a diagram showing a configuration of a laser beam printer optical system.

FIG. 12 is a ray diagram at a section in the scanning direction of an incidence optical system of a conventional laser beam printer.

FIG. 13 is a ray diagram at a section in the sub scanning direction of the incidence optical system of the conventional laser beam printer.

FIG. 14 is a ray diagram at a section in the scanning direction of an incidence optical system of a laser beam printer using the beam shaping element in the numerical value example 2.

FIG. 15 is a ray diagram at a section in the sub scanning direction of the incidence optical system of the laser beam printer using the beam shaping element in the numerical value example 2.

FIG. 16 is a ray diagram at the xz section of a beam shaping optical system in a numerical value example 3.

FIG. 17 is a ray diagram at the yz section of the beam shaping optical system in the numerical value example 3.

FIG. 18 is a ray diagram at the xz section of a beam shaping optical system in a numerical value example 4.

FIG. 19 is a ray diagram at the yz section of the beam shaping optical system in the numerical value example 4.

FIG. 20 is a diagram showing a configuration of a laser beam printer optical system in a numerical value example 5.

FIG. 21 is a ray diagram at the xz section of a beam shaping optical system in the numerical value example 5.

FIG. 22 is a ray diagram at the yz section of the beam shaping optical system in the numerical value example 5.

FIG. 23 is a diagram showing the amount of astigmatism and total wave aberration in the laser beam printer optical system in the numerical value example 5.

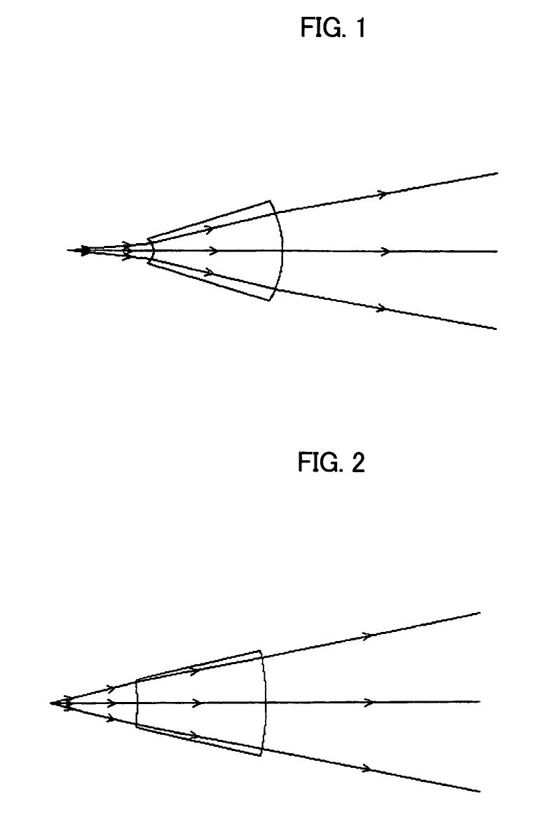

### BEST MODES FOR CARRYING OUT THE INVENTION

The variation in astigmatism due to change in environment is considered in a beam shaping element in which a diffraction grating is overlapped on an exit surface of an axially asymmetric single lens.

When a light source is located at a distance z from an image side focal point with respect to a beam shaping element having a focal distance f, a distance z′ from an object side focal point to a virtual image (forming image) point is expressed as follows.

$$\begin{matrix}[ Mathematical expression 1 ] & \\ {z}^{′} = \frac{{f}^{2}}{z} & ( 1 )\end{matrix}$$

Here, if it is assumed that the distance from the light source to a beam shaper incident surface is l, the distance from the light source to the virtual image point is l′, and the distance from the beam shaper incident surface to the image side main point is h, the following expression is obtained.

$$\begin{matrix}[ Mathematical expression 2 ] & \\ \begin{matrix}{l}^{′} = z + 2 f + {z}^{′} \\ = \frac{{( z + f )}^{2}}{z} \\ = \frac{{( l + h )}^{2}}{l + h - f}\end{matrix} & ( 2 )\end{matrix}$$

In an infinite conjugate system in which the beam shaper is caused to have a collimate function, l′ diverges, therefore, attention is paid to the inverse of l′. Due to the small change in the external factor (temperature) T, the refractive index n and the wavelength λ of the light source change infinitesimally and due to the variations in f and h, the location of the virtual image changes. This change is expressed by the following expression.

$$\begin{matrix}[ Mathematical expression 3 ] & \\ λ + Δ λ = λ + \frac{ⅆ λ}{ⅆ T} Δ T & ( 3 ) \\ n + Δ n = n + ( \frac{ⅆ n}{ⅆ T} + \frac{ⅆ n}{ⅆ λ} \frac{ⅆ λ}{ⅆ T} ) Δ T & ( 4 ) \\ \frac{1}{{l}^{′} + Δ {l}^{′}} = \frac{1}{l + h + Δ h} - \frac{f + Δ f}{{( l + h + Δ h )}^{2}} & ( 5 )\end{matrix}$$

If it is assumed that the central curvature of the incident surface is c1, the central curvature of the exit surface is c2, the thickness of the beam shaping element is d, the second order coefficient of the phase function of the exit surface is q, the refractive power at the incident surface is P1, and the total refractive and diffractive power at the exit surface is P2, respectively, the relationship between the small change Δλ, Δn and Δf, and Δh is obtained from the following expressions (6) to (9). By the way, here, only the coefficient of the second order term of the phase function, which is the largest influence on the power, is considered.

$$\begin{matrix}[ Mathematical expression 4 ] & \\ f = \frac{1}{{P}_{1} + {P}_{2} + \frac{{dP}_{1} {P}_{2}}{n}} & ( 6 ) \\ h = \frac{\frac{{dP}_{1}}{n}}{{P}_{1} + {P}_{2} + \frac{{dP}_{1} {P}_{2}}{n}} & ( 7 ) \\ {P}_{1} = ( n - 1 ) {c}_{1} & ( 8 ) \\ {P}_{2} = ( 1 - n ) {c}_{2} + \frac{λ q}{π} & ( 9 )\end{matrix}$$

Here, from the expressions (3) to (9), the small change of l′ in the expression (5) can be expressed as a function of ΔT. When n, d, P1, and P2 of the beam shaping element are determined and as the degree of freedom, only the distribution ratio between the refractive power and the diffractive power at the exit surface is left, and if high degree terms of the small change are ignored, the expression (5) can be expressed as follows,

$$\begin{matrix}[ Mathematical expression 5 ] & \\ \frac{1}{{l}^{′} + Δ {l}^{′}} = \frac{1}{{l}^{′}} + F ( q ) Δ T & ( 10 )\end{matrix}$$

and the small change in the inverse of the distance to the virtual image point is the product of a function F(q) defined by the expressions (3) to (9) and the small change ΔT.

In order not to have a large astigmatism for the environmental change, it is required for the virtual image points at the respective sections xz and yz to change similarly for the environmental change. The subscript x is assumed to indicate the xz section and the subscript y, the yz section, then, it is required to select second order coefficients qz and qy of the phase function which satisfy the following expression (11). Generally, at this time,

[Mathematical expression 6]
qₓ≠q_{y}
and a grating for astigmatism correction will be axially asymmetric.

$$\begin{matrix}[ Mathematical expression 7 ] & \\ \begin{matrix}\frac{1}{{l}_{x}^{′} + Δ {l}_{x}^{′}} == \frac{1}{{l}_{y}^{′} + Δ {l}_{y}^{′}} \\ {{F}_{x} ( {q}_{x} )}^{∴} = {F}_{y} ( {q}_{y} )\end{matrix} & ( 11 )\end{matrix}$$

In the above, the case is explained, where the astigmatism is minimized by causing the change in the distance from the light source to the image forming point or the virtual image point on the xz plane to be equal to the change in the relevant distance on the yz plane for the change in temperature. In the case where the astigmatism is minimized for the change in the light source wavelength, it is possible to deal with similarly by the following expression instead of the expressions (3) and (4), only the change in refractive index due to the change in wavelength being taken into account.

$$n + Δ n = n + \frac{ⅆ n}{ⅆ λ} Δ λ \qquad [ Mathematical expression 8 ]$$

Next, numerical value examples are explained.

### NUMERICAL VALUE EXAMPLE 1

In a beam shaping element according to the present numerical value example 1, the energy distribution at the section of a ray bundle after passing through the optical element and perpendicular to the optical axis is substantially axially symmetric and at the same time, optimization is performed so as to suppress the occurrence of astigmatism and spherical aberration due to the change in the light source wavelength when best focused. Therefore, the beam shaping element is suitable for a pickup of a blue ray optical storage etc.

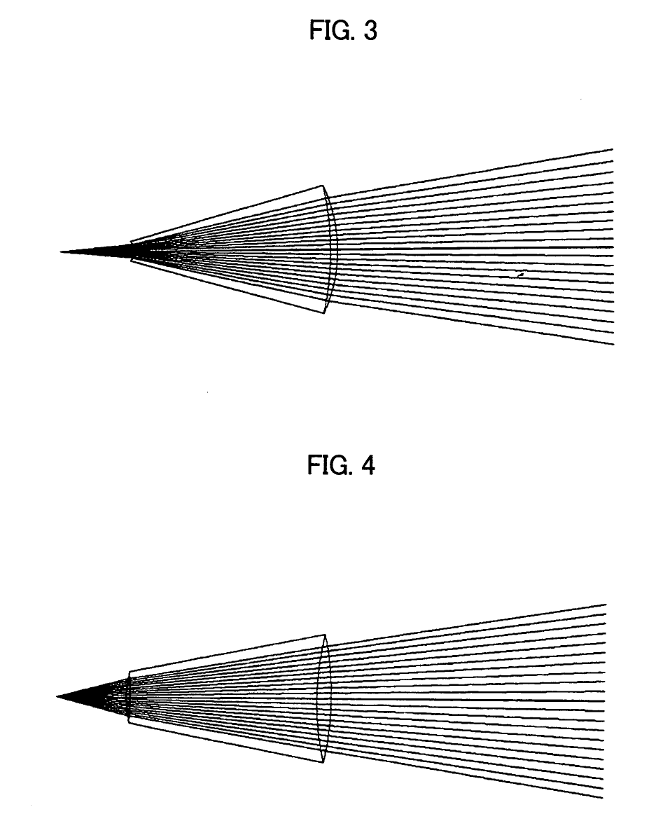

FIG. 3 and FIG. 4 are ray diagrams at the xz section and the yz section of the beam shaping element in the numerical value example 1.

The beam shaping element according to the numerical value example 1 has a free-form surface expressed by the expression (12) as a first surface and a second surface. The free-form surface is one in which polynomials of x and y are added as correction terms to a so-called biconic having respective different curvatures and conical coefficients at the section in the horizontal direction (xz section) and the section in the vertical direction (yz section). By the way, other surfaces such as an anomorphic aspherical surface etc. may be used instead of the free-form surface of the expression (12).

$$\begin{matrix}[ Mathematical expression 9 ] & \\ z = \frac{{c}_{x} {x}^{2} + {c}_{y} {y}^{2}}{1 + \sqrt{1 - ( 1 + {k}_{x} ) {c}_{x}^{2} {x}^{2} - ( 1 + {k}_{y} ) {c}_{y}^{2} {y}^{2}}} + {a}_{4} {x}^{4} + {a}_{6} {x}^{6} + \\ {a}_{8} {x}^{8} + {a}_{10} {x}^{10} + {b}_{4} {y}^{4} + {b}_{6} {y}^{6} + {b}_{8} {y}^{8} + {b}_{10} {y}^{10} & ( 12 )\end{matrix}$$

Further, to the second surface, an axially asymmetric diffraction grating is added, which has polynomials of x and y in the expression (13) as a phase function.
[Mathematical expression 10]
φ=p₂x²+p₄x⁴+p₆x⁶+q₂y²+q₄y⁴+q₆y⁶ (13)

By the way, as a refractive index, n=1.657 is used for the designed wavelength λ=405 μm. The lens data is as follows.

| | | | |
|---|---|---|---|
| Distance between light | 1.494 | Distance between | 3.0 |
| source and first surface | | lens surfaces | |
| NA before incidence | 0.0958 | NA before incidence | 0.259 |
| (x direction) | | (y direction) | |
| NA after emission | 0.167 | NA after emission | 0.167 |
| (x direction) | | (y direction) | |

First surface free-form surface coefficients

| | | |
|---|---|---|
| cx = −3.746, | kx = 1.328 | a4 = −4.526E−1, |
| a6 = 0.0, | a8 = 0.0, | a10 = 0.0 |
| cy = −1.550E−1, | ky = 0.0 | b4 = −2.510E−2 |
| b6 = 0.0, | b8 = 0.0, | b10 = 0.0 |

Second surface free-form surface coefficients

| | | |
|---|---|---|
| cx = −3.944E−1, | kx = 6.257E−1 | a4 = −4.526E−1, |
| a6 = 0.0, | a8 = 0.0, | a10 = 0.0 |
| cy = −2.028E−1, | ky = 8.609E−1 | b4 = 7.906E−4 |
| b6 = 0.0, | b8 = 0.0, | b10 = 0.0 |

Second surface phase function coefficients

| | | |
|---|---|---|
| p2 = −9.393E1, | p4 = 0.0, | p6 = 0.0 |
| q2 = −1.645E2, | q4 = 0.0, | q6 = 0.0 |

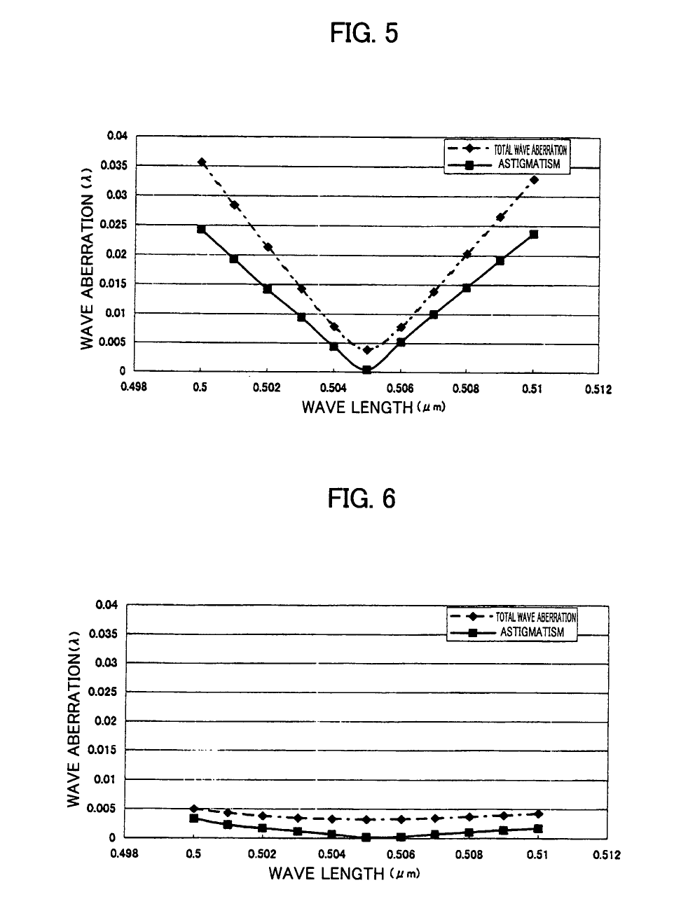

FIG. 5 is a diagram showing a relationship between the variation in wavelength and aberration when best focused after the emission by a beam shaping element not having the astigmatism correction function. In FIG. 5, the vertical axis represents the total wave aberration and astigmatism and the horizontal axis represents the variation in wavelength. The above-mentioned beam shaping element not having the astigmatism correction function comprises the same optical characteristics as those in the numerical value example 1 except for the chromatic aberration correction by the diffraction grating. By the way, the relationship between the refractive index and the wavelength is assumed to be dn/dλ=−1.467E−4.

In FIG. 5, a wave aberration of about 30 mλ occurs for the variation in wavelength of 0.005μ and most of the components are astigmatism.

In contrast to this, FIG. 6 shows the relationship between the variation in wavelength and aberration of the beam shaping element in the numerical value example 1 as a similar graph. In addition to that the occurrence of astigmatism is well suppressed, the components of the spherical aberration are suppressed more or less by the axially symmetric grating components, therefore, there is almost no occurrence of wave aberration due to the variation in wavelength.

Here, the case where the beam shaping element in the present numerical value example 1 is applied to an optical pickup system is explained.

In general, an optical pickup system comprises an actuator mechanism for moving an optical element so as to cancel the defocus component as needed, therefore, it is not necessary for the lens itself to cancel the defocus component except in a transition state. Therefore, also in the numerical value example 1, optimization is performed such that the defocus component is left. Further, the evaluation of aberration is performed at a best-focused plane. By utilizing the remaining degree of freedom, it is made possible to reduce the variation in spherical aberration due to the change in the light source wavelength. It is also possible to design so as to cancel the defocus component as the need arises.

### NUMERICAL VALUE EXAMPLE 2

The beam shaping element according to the present numerical value example 2 is designed so as to prevent not only the occurrence of astigmatism due to the change in temperature but also the occurrence of defocus. Further, the beam after shaping is collimated light and the energy distribution at its section is the shape of an ellipse with a small aspect ratio of 4 to 3, resulting in being most suitable for a light source of, for example, a laser beam printer. By the way, the refractive index is set to 1.486 for the laser wavelength 780 nm.

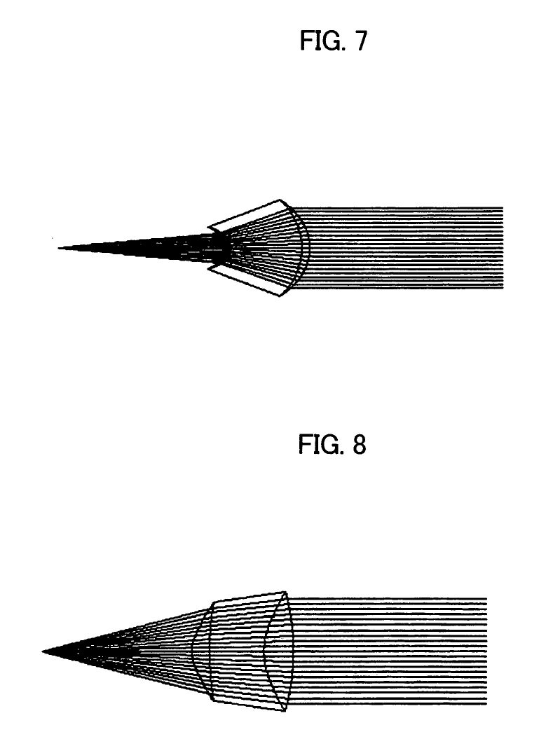

FIG. 7 and FIG. 8 are ray diagrams at the xz section and the yz section of the beam shaping element in the numerical value example 2.

The beam shaping element according to the numerical value example 2 is a beam shaping element constituted by an incidence surface that can be represented as the free-form surface by the expression (1) and an exit surface, which is the free-form surface by the expression (1) overlapped by the grating surface of the phase difference represented by the expression (2). Each coefficient in the numerical value example 2 is as follows.

| | | | |
|---|---|---|---|
| Distance between light | 6.024 | Distance between | 3.0 |
| source and first surface | | lens surfaces | |
| NA before incidence | 0.0958 | NA before incidence | 0.259 |
| (x direction) | | (y direction) | |
| Beam radius after | 1.5 | Beam radius after | 2.0 |
| emission (x direction) | | emission (y direction) | |

First surface free-form surface coefficients

| | | |
|---|---|---|
| cx = −1.474, | kx = −4.680E−1 | a4 = −2.805E−2, |
| a6 = −1.543E−3, | a8 = 2.296E−3, | a10 = 0.0 |
| cy = 9.617E−2, | ky = −1.433E1 | b4 = −6.962E−4 |
| b6 = 2.099E−6, | b8 = 4.996E−7, | b10 = 0.0 |

Second surface free-form surface coefficients

| | | |
|---|---|---|
| cx = −5.214E−1, | kx = −2.963E−1 | a4 = −1.077E−3 |
| a6 = −1.681E−6, | a8 = 7.919E−7, | a10 = 0.0 |
| cy = −1.049E−1, | ky = 2.087 | b4 = 1.030E−4 |
| b6 = −2.304E−7, | b8 = 9.710E−8, | b10 = 0.0 |

Second surface phase function coefficients

| | | |
|---|---|---|
| p2 = −2.575E2, | p4 = 3.139E−2, | p6 = 0.0 |
| q2 = −1.822E2, | q4 = −6.758E−3, | q6 = 0.0 |

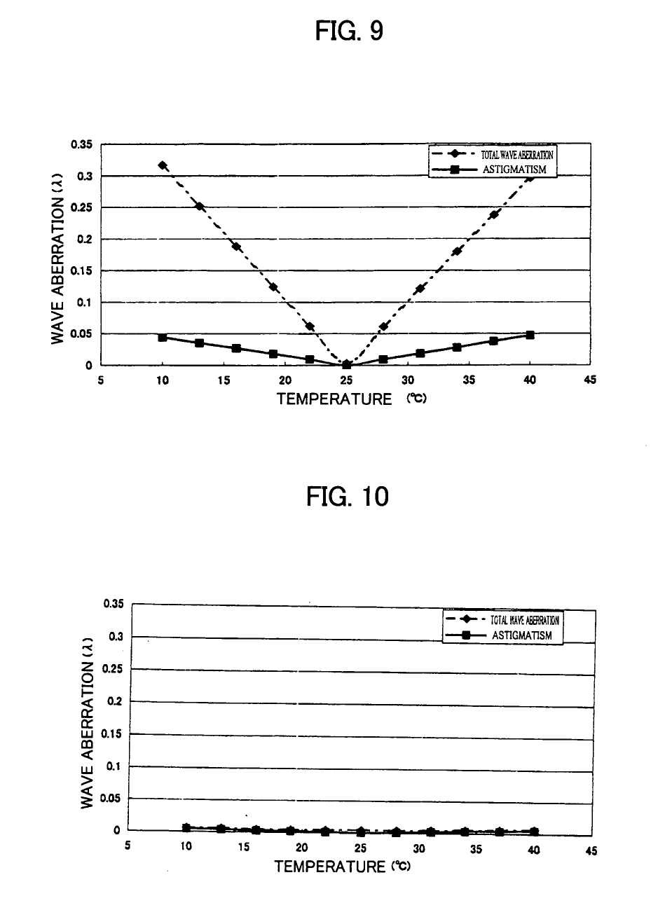

FIG. 9 is a diagram showing a relationship between the variation in temperature and aberration of the beam shaping element not having the astigmatism correction function. In FIG. 9, the vertical axis represents the total wave aberration and astigmatism and the horizontal axis represents the variation in wavelength at the location of the fixed image after emitted from the beam shaping element. The above-mentioned shaping element not having the astigmatism correction function has the same optical characteristics as those of the beam shaping element in the numerical value example 2 except for the temperature compensating function by the diffraction grating. However, it is assumed that the relationship between the refractive index, light source wavelength, and temperature obeys the following relational expression.
dn/dλ=−1.492E−5
dn/dT=−1.173E−4
dλ/dT=0.2

In FIG. 9, the change in refractive index is remarkable and most of the wave aberration is the defocus component, however, it is apparent that the astigmatism also has a large value and the aberration cannot be reduced completely even if the distance between the light source and the incidence surface etc. is adjusted.

FIG. 10 is a diagram showing a relationship between the variation in temperature and aberration of the beam shaping element in the numerical value example 2. The occurrence of wave aberration in addition to astigmatism is remarkably suppressed.

Here, the case is explained, where the beam shaping element in the present numerical value example 2 is applied to a laser beam printer (LBP) optical system.

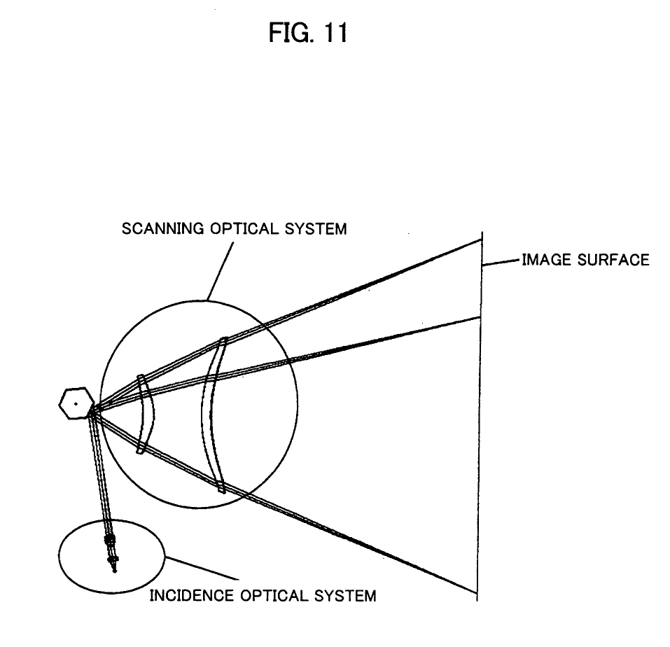

As shown in FIG. 11, an LBP optical system is constituted basically by an incidence optical system for making diffused light from a light source into parallel to adjust the ellipticity arbitrarily, a deflecting element (polygon mirror) for changing the direction of the ray of light, and a scanning optical system for forming an image at a desired location on the image surface. By the way, it is general for the incidence optical system to include a cylindrical lens having power only in the direction perpendicular to the scanning direction (sub scanning direction). The purpose of this is to obtain an optical system in which an image is formed on a polygon mirror only in the sub scanning direction and there is an effect to relax the vertical accuracy tolerance (tolerance for a so-called optical face tangle error) on a polygon mirror surface.

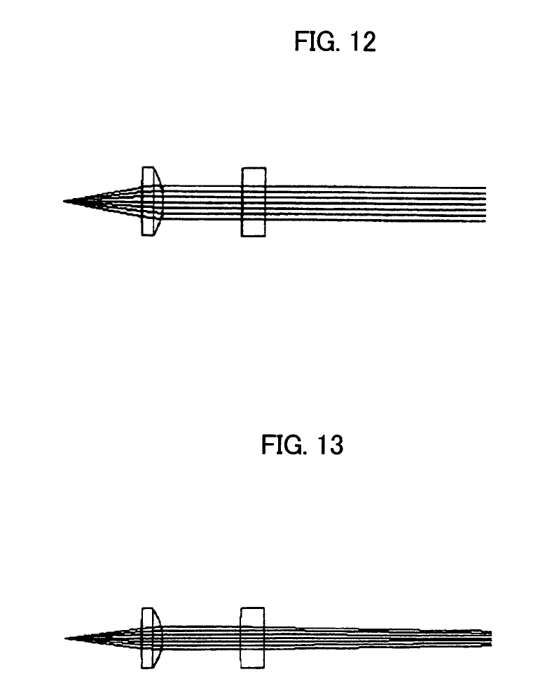

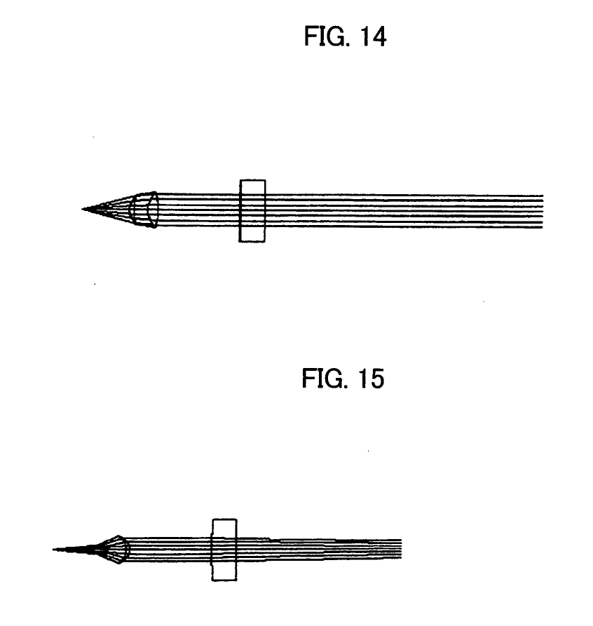

The beam shaping element in the present numerical value example 2 is replaced with the collimator in the incidence optical system or is inserted in front of the collimator as a result. It is possible to use the same deflecting element and scanning optical system as those in an existing LBP except for the incidence optical system. FIG. 12 and FIG. 13 show optical path diagrams at the sections in the scanning direction and sub scanning direction of a conventional incidence optical system. FIG. 14 and FIG. 15 show ray diagrams at the sections in the scanning direction and sub scanning direction of the incidence optical system comprising the beam shaping element in the present numerical value example 2.

### NUMERICAL VALUE EXAMPLE 3

In a beam shaping optical system according to the present numerical value example 3, the refractive lens and the diffraction grating are separated and the diffraction grating is arranged at a plate-like element. Therefore, compared with the case where the diffraction grating is arranged on the surface of the refractive lens, its mold can be produced more easily and its manufacture is easier.

The beam shaping element according to the present numerical value example 3 is designed so as to prevent not only the occurrence of astigmatism due to the change in temperature but also the occurrence of defocus. Further, the beam after shaping is collimated light and the energy distribution at its section is the shape of an ellipse with a small aspect ratio of 4 to 3. By the way, the refractive index is set to 1.486 for the laser wavelength 780 nm.

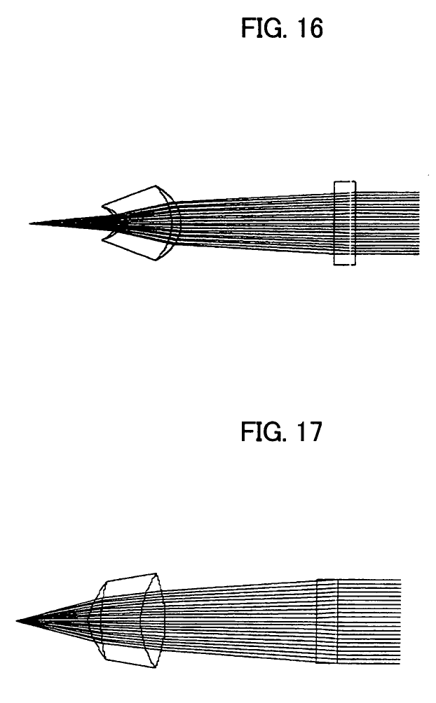

FIG. 16 and FIG. 17 are ray diagrams at the xz section and the yz section of the beam shaping optical system in the numerical value example 3.

The beam shaping element according to the numerical value example 3 comprises a beam shaping element constituted by an incidence surface that can be represented as the free-form surface by the expression (1) and an exit surface that can be represented as the free-form surface by the expression (1) and a diffraction grating plate with the phase function by the expression (2) on the second surface. Each coefficient in the numerical value example 3 is as follows.

| | | | |
|---|---|---|---|
| Distance between light source | 4.0 | Distance between | 3.0 |
| and lens first surface | | lens surfaces | |
| Distance between lens second | 7.113 | Distance between | 1.0 |
| surface and grating plate first | | grating plate surfaces | |
| surface | | | |
| NA before incidence | 0.0958 | NA before incidence | 0.259 |
| (x direction) | | (y direction) | |
| Beam radius after emission | 1.5 | Beam radius after | 2.0 |
| (x direction) | | emission (y direction) | |

First lens first surface free-form surface coefficients

| | | |
|---|---|---|
| cx = −1.414, | kx = −3.672E−1 | a4 = −2.805E−2, |
| a6 = −1.543E−3, | a8 = 2.296E−3, | a10 = 0.0 |
| cy = 1.366E−1 | ky = −1.216E1 | b4 = −6.832E−4 |
| b6 = 5.394E−4, | b8 = 0.0, | b10 = 0.0 |

First lens second surface free-form surface coefficients

| | | |
|---|---|---|
| cx = −5.612E−1, | kx = −3.477E−1 | a4 = −1.077E−3 |
| a6 = −1.681E−6, | a8 = 7.919E−7, | a10 = 0.0 |
| cy = −1.775E−1, | ky = 4.813E−1 | b4 = 1.314E-3 |
| b6 = −1.945E−4, | b8 = 0.0, | b10 = 0.0 |

Grating plate second surface phase function coefficients

| | | |
|---|---|---|
| p2 = −1.481E2, | p4 = 0.0, | p6 = 0.0 |
| q2 = −1.403E2, | q4 = 0.0, | q6 = 0.0 |

Here, the designed temperatures are set to 10° C. to 40° C. and it is assumed that the relationship between the light source wavelength and temperature obeys the following relational expression.
dn/dλ=−1.492E−5
dn/dT=−1.173E−4
dλ/dT=0.2

### NUMERICAL VALUE EXAMPLE 4

A beam shaping optical system according to the present numerical value example 4 includes two beam shaping elements. A first beam shaping element is a refractive lens having an axially asymmetric refracting surface on both sides, having the beam shaping function. On a first surface of a second beam shaping element, a diffraction grating surface having an axially asymmetric phase function is arranged and on a second surface, a diffraction grating surface having an axially symmetric phase function is arranged. Further, the second surface of the second beam shaping element is an axially symmetric refracting surface and on its surface, a diffraction grating surface having an axially symmetric phase function is overlapped. In this beam shaping optical system, beam shaping and astigmatism correction are performed at the first optical element and at the first surface of the second element and the ray bundle is turned parallel and correction of defocus is performed at the final surface.

The beam shaping element according to the present numerical value example 4 is designed so as to prevent not only the occurrence of astigmatism due to the change in temperature but also the occurrence of defocus. Further, the beam after shaping is collimated light and the energy distribution at its section is the shape of an ellipse with a small aspect ratio of 11 to 10. By the way, the refractive index is set to 1.486 for the laser wavelength 780 nm.

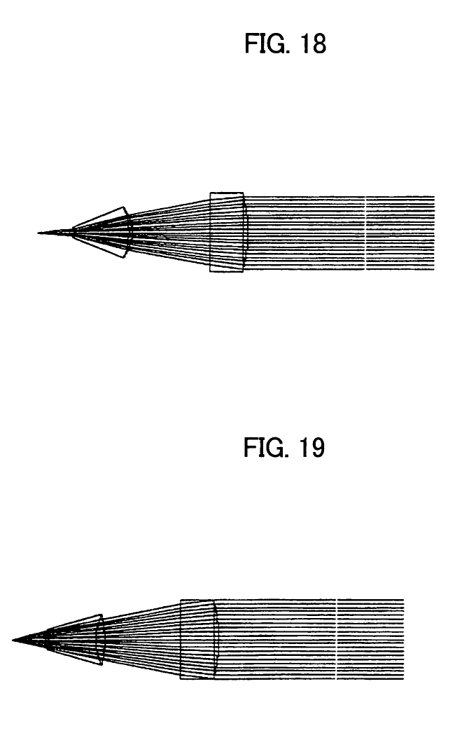

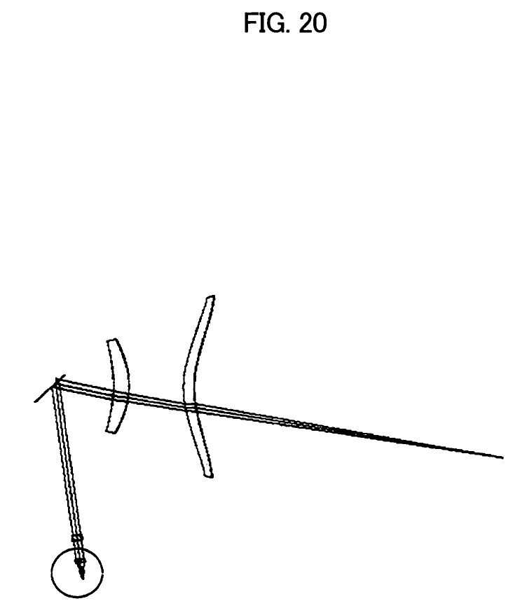

FIG. 18 and FIG. 19 are ray diagrams at the xz section and the yz section of the beam shaping optical system in the numerical value example 4.

The beam shaping optical system according to the numerical value example 4 is constituted by an incidence surface that can be represented as the free-form surface by the expression (1) and an exit surface that can be represented as the free-form surface by the expression (1) and comprises a first optical element and a second optical element having the beam shaping function. The second optical element comprises a diffraction grating that can be represented by the phase function by the expression (2) on a first surface and a diffraction grating that can be represented by the refracting surface by the following expression (14) and the phase function by the expression (15), where r is the distance from the optical axis, on a second surface. Here, the phase function by the expression (2) arranged on the first surface of the second optical element consists of only x terms, has power only in the x direction, and is axially asymmetric. The refracting surface by the expression (14) and the phase function by the expression (15) of the second optical element are axially symmetric. As described above, correction of astigmatism is performed at the first surface of the second optical element and the ray bundle is turned into parallel and correction of defocus is performed at the second surface of the second optical element.

$$\begin{matrix}[ Mathematical expression 11 ] & \\ z = \frac{{cy}^{2}}{1 + \sqrt{1 - ( 1 + k ) {c}^{2} {y}^{2}}} + a 4 {y}^{4} + a 6 {y}^{6} + a 8 {y}^{8} + a 10 {y}^{10} & ( 14 ) \\ ϕ = p 2 {r}^{2} + p 4 {r}^{4} + p 6 {r}^{6} & ( 15 )\end{matrix}$$

Each coefficient in the numerical value example 4 is as follows.

| | | | |
|---|---|---|---|
| Distance between light | 2.0 | Distance between | 3.0 |
| source and lens first | | first lens surfaces | |
| surface | | | |
| Distance between first | 4.068 | Distance between | 2.0 |
| lens and second lens | | second lens surfaces | |
| NA before incidence | 0.0958 | NA before incidence | 0.259 |
| (x direction) | | (y direction) | |
| Beam radius after | 2.0 | Beam radius after | 2.2 |
| emission (x direction) | | emission (y direction) | |

First lens first surface free-form surface coefficients

| | | |
|---|---|---|
| cx = −3.175, | kx = −1.911 | a4 = −6.250, |
| a6 = 0.0, | a8 = 0.0, | a10 = 0.0 |
| cy = −1.338E−1 | ky = −1.974E1 | b4 = 1.716E−2 |
| b6 = 0.0, | b8 = 0.0, | b10 = 0.0 |

First lens second surface free-form surface coefficients

| | | |
|---|---|---|
| cx = −4.260E−1, | kx = −1.370E−2 | a4 = −6.187E−5 |
| a6 = 0.0, | a8 = 0.0, | a10 = 0.0 |
| cy = −1.709E−1, | ky = 1.077 | b4 = 8.668E−4 |
| b6 = −0.0, | b8 = 0.0, | b10 = 0.0 |

Second lens first surface phase function coefficients

| | | |
|---|---|---|
| p2 = −1.397E1, | p4 = 0.0, | p6 = 0.0 |
| q2 = 0.0, | q4 = 0.0, | q6 = 0.0 |

Second lens second surface aspherical surface coefficients

| | | |
|---|---|---|
| c = −1.197E−1, | k = 0.0, | a4 = 2.039E−4 |
| a6 = 3.156E−7, | a8 = 7.919E−7, | a10 = 0.0 |

Second lens second surface phase function coefficients

| | | |
|---|---|---|
| p2 = −1.407E2, | p4 = 4.091E−1, | p6 = 0.0 |

Here, the designed wavelength is set to 780 nm, the designed temperatures are set to 10° C. to 40° C. and it is assumed that the relationship between the refractive index, light source wavelength, and temperature obeys the following relational expression.
dn/dλ=−1.492E−5
dn/dT=−1.173E−4
dλ/dT=0.2

### NUMERICAL VALUE EXAMPLE 5

In a laser beam printer optical system in a numerical value example 5, the grating power is adjusted so that defocus and astigmatism due to the environmental variation become small, including not only the beam shaping element but also the scanning optical system. A configuration of the laser beam printer optical system in the numerical value example 5 is shown in FIG. 20. The laser beam printer optical system in the numerical value example 5 includes two beam shaping elements 1 and 2, a cylindrical lens, a deflecting element, and two scanning lenses 1 and 2.

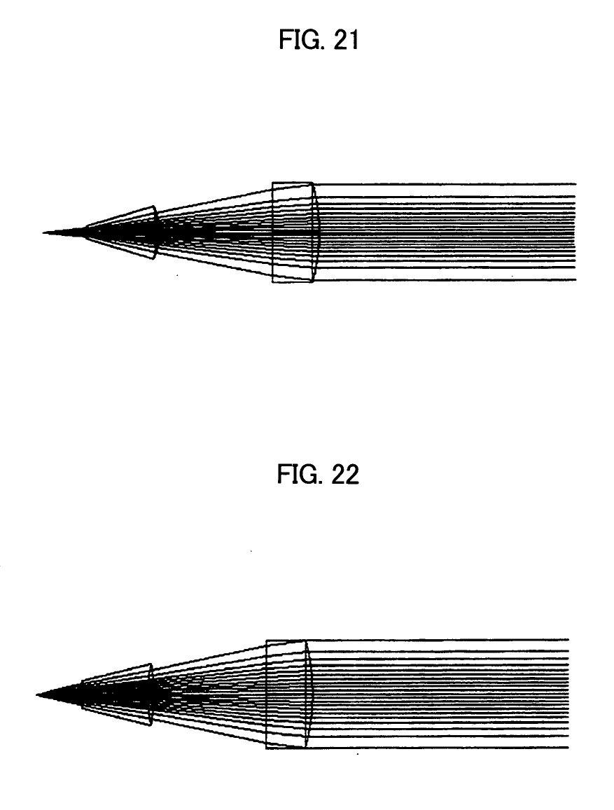

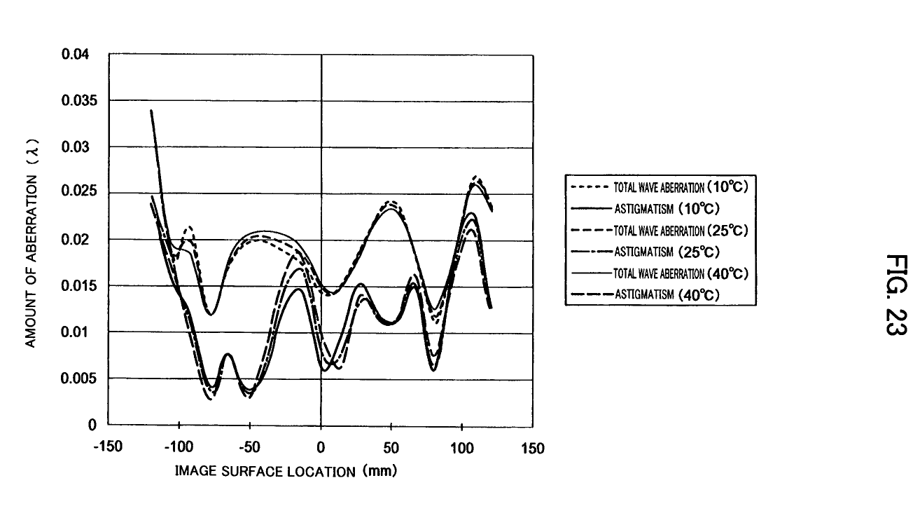

FIG. 21 and FIG. 22 are ray diagrams at the xz section and the yz section in the beam shaping optical system in the laser beam printer optical system in the numerical value example 5.

As in the case of the numerical value example 4, the beam shaping optical system according to the numerical value example 5 is constituted by an incidence surface that can be represented as the free-form surface by the expression (1) and an exit surface that can be represented as the free-form surface by the expression (1) and comprises a first optical element and a second optical element having the beam shaping function. The second optical element comprises a diffraction grating that can be represented by the phase function by the expression (2) on a first surface and a diffraction grating that can be represented by the refracting surface by the expression (14) and the phase function by the expression (15), where r is the distance from the optical axis, on a second surface. Here, the phase function by the expression (2) arranged on the first surface of the second optical element consists of only x terms, has power only in the x direction, and is axially asymmetric. The refracting surface by the expression (14) and the phase function by the expression (15) of the second optical element are axially symmetric.

$$\begin{matrix}[ Mathematical expression 12 ] & \\ z = \frac{{cr}^{2}}{1 + \sqrt{1 - ( 1 + k ) {c}^{2} {r}^{2}}} + a 4 {r}^{4} + a 6 {r}^{6} + a 8 {r}^{8} + a 10 {r}^{10} & ( 14 ) \\ ϕ = p 2 {r}^{2} + p 4 {r}^{4} + p 6 {r}^{6} & ( 15 )\end{matrix}$$

In this beam shaping optical system, beam shaping and astigmatism correction are performed at the first optical element and at the first surface of the second element and the ray bundle is turned into parallel and correction of defocus is performed at the final surface. Correction of astigmatism and correction of focus include correction of the cylindrical lens and the two scanning lenses. The configuration and each coefficient of the scanning optical system in the numerical value example 5 are as follows.

TABLE 1

| | | GLASS |
|---|---|---|
| | THICKNESS(mm) | MATERIAL |
| LIGHT SOURCE | 2 | |
| BEAM SHAPING ELEMENT 1 | 3 | PMMA |
| | 4.84118 | |
| BEAM SHAPING ELEMENT 2 | 2 | PMMA |
| | 11 | |
| CYLINDRICAL | 3 | BK7 |
| | 83.478 | |
| DEFLECTING ELEMENT | 0 | |
| | 26.054 | |
| SCANNING LENS 1 | 8.606 | PMMA |
| | 30 | |
| SCANNING LENS 2 | 6.045 | PMMA |
| | 171.045 | |
| IMAGE SURFACE | | |

| | | | |
|---|---|---|---|
| Raw material: PMMA | | | |
| NA before incidence | 0.0958 | NA before incidence | 0.233 |
| (parallel) | | (vertical) | |
| Beam radius after | 2.183 | Beam radius after | 2.268 |
| emission (parallel) | | emission (vertical) | |

Surface shape coefficients
Beam shaping element section
Beam shaping element first lens first surface free-form
surface coefficients

| | | |
|---|---|---|
| cx = −2.453, | kx = −4.443 | a4 = −8.051 |
| a6 = 0.0, | a8 = 0.0, | a10 = 0.0 |
| cy = −1.450E−1 | ky = 2.525E1 | b4 = 2.656E-2 |
| b6 = 0.0, | b8 = 0.0, | b10 = 0.0 |

Beam shaping element first lens second surface free-form
surface coefficients

| | | |
|---|---|---|
| cx = −3.458E−1, | kx = −1.456 | a4 = −6.421E−4 |
| a6 = 0.0, | a8 = 0.0, | a10 = 0.0 |
| cy = −1.283E−1, | ky = −1.501 | b4 = 1.144E−3 |
| b6 = −0.0, | b8 = 0.0, | b10 = 0.0 |

Beam shaping element second lens first surface phase
function coefficients

| | | |
|---|---|---|
| p2 = −1.220E1, | p4 = −2.068, | p6 = 3.830E−2 |
| q2 = 0.0, | q4 = 0.0, | q6 = 0.0 |

Beam shaping element second lens second surface aspherical
surface coefficients

| | | |
|---|---|---|
| c = −1.143E−1, | k = 0.0, | a4 = 7.957E−5 |
| a6 = 1.599E−6, | a8 = −8.069E−7, | a10 = 0.0 |

Beam shaping element second lens second surface phase
function coefficients

| | | |
|---|---|---|
| p2 = −1.387E2, | p4 = −2.857E−1, | p6 = 2.333E−2 |

Cylindrical lens
Curvature radius

r = 4.7044E1

Scanning optical system
Scanning optical system first lens first surface
(axially symmetric aspherical surface

| | | |
|---|---|---|
| c = −1.469E−2, | k = −3.922, | a4 = 2.346E−6 |
| a6 = 3.877E−9, | a8 = −9.383E−12, | a10 = 3.595E−15 |

Scanning optical system first lens second surface
(toroidal surface)

| | | |
|---|---|---|
| c = −2.294E−2, | k = −2.976E−1 | a4 = 2.694E−6 |
| a6 = 4.259E−9, | a8 = −5.427E−12, | a10 = 7.776E−16 |
| r = −3.709E1 | | |

Scanning optical system second lens first surface
(toroidal surface)

| | | |
|---|---|---|
| c = 1.684E−2, | k = −2.086E−1, | a4 = −3.159E−6 |
| a6 = 9.659E−10, | a8 = −3.004E−13, | a10 = 3.138E−17 |
| r = Infinite | | |

Scanning optical system second lens second surface
(toroidal surface)

| | | |
|---|---|---|
| c = 1.656E−2, | k = −2.277E−1, | a4 = −3.374E−6 |
| a6 = 1.203E−9, | a8 = −3.422E−13, | a10 = 3.473E−17 |
| r = −2.852E1 | | |

The shape of the surface at the section of the scanning surface including the optical axis of the toroidal surface in the present example, that is, the shape of the generatrix is represented by the following expression (16). Further, the coefficient r in the data of the shape of toroidal surface is a rotation radius with which the generatrix is rotated.

$$[ Mathematical expression 13 ]$$

$$z = \frac{{cy}^{2}}{1 + \sqrt{1 - ( 1 + k ) {c}^{2} {y}^{2}}} + a 4 {y}^{4} + a 6 {y}^{6} + a 8 {y}^{8} + a 10 {y}^{10} \qquad ( 16 )$$

Here, the designed wavelength is set to 780 nm and the designed temperatures are set to 10° C. to 40° C. As to the PMMA (polymethylmetacrylate, acrylate resin), it is assumed that the refractive index is set to 1.486 for the laser wavelength 780 nm and the relationship between the refractive index, light source wavelength, and temperature obeys the following relational expression.
dn/dλ=−1.492E−5
dn/dT=−1.173E−4
dλ/dT=0.2

As to the optical glass BK7 used for the cylindrical lens, it is assumed that the refractive index is set to 1.511 for the laser wavelength 780 nm and the relationship between the refractive index, light source wavelength, and temperature obeys the following relational expression.
dn/dλ=−2.089−5
dn/dT=−2.535E−6

The amount of the astigmatism and the total wave aberration in the laser beam printer optical system in the numerical value example 5 is shown in FIG. 23. The change in the amount of aberration is very small compared to the change in the environmental temperature. In contrast to this, when a beam forming element made of resin not having a temperature compensating mechanism is inserted immediately after a light source of an optical system with a high image magnification such as one used in a laser beam printer, the occurrence of astigmatism and defocus is remarkable and the image forming location shifts by several millimeters or more from the image surface in the direction of optical axis, therefore, it cannot be put to practical use.

Method for Manufacturing Optical Element

Optical elements according to the present invention are manufactured by injection molding.

If it is assumed that φ is a phase function and n and m are both integers, then a curve at which φ=2 nm π on the xy plane will be the n-th grating. Therefore, when the grating interval in the x direction is H, the following expression is obtained.

$$[ Mathematical expression 14 ]$$

$$H = \frac{2 m π}{\frac{ⅆ ϕ}{ⅆ x}}$$

Specifically, the phase function of the second surface in the numerical value example
2 is
   φ=−257.5x²+0.03139x⁴−188.2y²−0.006758y⁴
   therefore, the pitch at the location x=1 mm from the center when m=1 is as follows.
   H=2*3.14/(257.5*2*1−0.03139*4*13)=0.0122 (mm)
   Here, * shows multiplication. Since the effective radius in the x direction of the element is 1.5 mm, the pitch at the end is about 8 μm. As described above, the interval of the diffraction grating in each of the numerical value examples is several hundreds μm at most to about 10 μm pitch.

Therefore, it is possible to machine a mold by a three-dimensional machining device comprising plural machining axes even for a surface, which is a curved surface on which a blazed diffraction grating is overlapped.

As a material for optical elements, resin such as PMMA (polymethyl metacrylate, acrylate resin) is used. It may also be possible to use flint glass etc. In the numerical value example 1, flint glass was used and in the numerical value examples 2 to 5, PMMA was used.

1. A beam shaping optical system including a beam shaping element having an axially asymmetric profile, for shaping the shape of a beam from a light source, comprising a diffraction grating surface that has determined a phase function in the x axis direction and in the y axis direction so as to minimize astigmatism by causing the change in the inverse of a distance from the light source to an image forming point or a virtual image point on the xz plane to be equal to the change in the inverse of a relevant distance on the yz plane for the change in the light source wavelength when the optical axis is taken as the z axis and the plane perpendicular to the optical axis is taken as the xy plane.

2. A beam shaping optical system including a beam shaping element having an axially asymmetric profile, for shaping the shape of a beam from a light source, comprising a diffraction grating surface that has determined a phase function in the x axis direction and in the y axis direction so as to minimize astigmatism by causing the change in the inverse of a distance from the light source to the image forming point or the virtual image point on the xz plane to be equal to the change in the inverse of a relevant distance on the yz plane for the change in temperature when the optical axis is taken as the z axis and the plane perpendicular to the optical axis is taken as the xy plane.

3. The beam shaping optical system according to claim 1, wherein a phase function has been further determined in the x axis direction and in the y axis direction so as to minimize the change in the inverse of the distance from the light source to the image forming point or the virtual image point on the xz plane and the change in the inverse of the relevant distance on the yz plane for the change in the light source wavelength or the change in temperature.

4. The beam shaping optical system according to claim 1, wherein a phase function has been further determined in the x axis direction and in the y axis direction so as to minimize the amount of spherical aberration for the change in the light source wavelength or the change in temperature.

5. The beam shaping optical system according to claim 1, wherein the phase function of the diffraction grating includes a term consisting of an even function of either or both of x and y.

6. The beam shaping optical system according to claim 1, wherein the light source is a semiconductor laser, an active layer of the semiconductor laser is parallel to an xz section, and the beam from the laser light source, the portion of which, where a ratio of the intensity at a plane perpendicular to the optical axis to the peak intensity is equal to or greater than a predetermined value, can be represented by an ellipse, is shaped into a beam, the portion of which, where a relevant ratio is equal to or greater than the predetermined value, can be represented by substantially a circle.

7. The beam shaping optical system according to claim 6, used in an optical pickup device.

8. The beam shaping optical system according to claim 1, wherein the light source is a semiconductor laser, the active layer of the semiconductor laser is parallel to the xz section, and the beam from the laser light source, the portion of which, where a ratio of the intensity at a plane perpendicular to the optical axis to the peak intensity is equal to or greater than a predetermined value, can be represented by an ellipse, is shaped into a beam, the portion of which, where a relevant ratio is equal to or greater than the predetermined value, can be represented by an ellipse the ratio between the major axis and the minor axis of which is different from that of the ellipse.

9. The beam shaping optical system according to claim 8, used in a laser beam printer optical system.

10. The beam shaping optical system according to claim 1, constituted by a single lens.

11. The beam shaping optical system according to claim 1, wherein the diffraction grating surface is separated from the beam shaping element.

12. The beam shaping optical system according to claim 1, wherein a diffraction grating surface having an axially symmetric phase function and a diffraction grating surface having a phase function consisting of only x terms or y terms are separated.

13. The beam shaping optical system according to claim 12, wherein the diffraction grating surface having an axially symmetric phase function is overlapped on an axially symmetric refracting surface.

14. A laser beam printer optical system including a beam shaping element having an axially asymmetric profile, for shaping the shape of a beam from a light source, comprising a diffraction grating surface that has determined a phase function in the x axis direction and in the y axis direction so as to minimize astigmatism by causing the change in the inverse of a distance from the light source to an image forming point on the xz plane to be equal to the change in the inverse of a relevant distance on the yz plane for the change in temperature when the optical axis is taken as the z axis and the plane perpendicular to the optical axis is taken as the xy plane.

15. The laser beam printer optical system according to claim 14, wherein a phase function has been further determined so as to minimize the change in the inverse of the distance from the light source to the image forming point on the xz plane and the change in the inverse of the relevant distance on the yz plane for the change in temperature.

16. The laser beam printer optical system according to claim 14, wherein the beam shaping element shapes the beam from the laser light source, the portion of which, where a ratio of the intensity at a plane perpendicular to the optical axis to the peak intensity is equal to or greater than a predetermined value, can be represented by an ellipse, into a beam, the portion of which, where a relevant ratio is equal to or greater than the predetermined value, can be represented by an ellipse the ratio between the major axis and the minor axis of which is different from that of the ellipse.

17. The laser beam printer optical system according to claim 14, wherein the diffraction grating surface is separated from the beam shaping element.

18. The laser beam printer optical system according to claim 14, wherein a diffraction grating surface having an axially symmetric phase function and a diffraction grating surface having a phase function consisting of only x terms or y terms are separated.

19. The laser beam printer optical system according to claim 18, wherein the diffraction grating surface having an axially symmetric phase function is arranged on the axially symmetric refracting surface.
